(19) United States
(12) Patent Application Publication
(10) Pub. No.: US 2024/0222692 A1
(43) Pub. Date: Jul. 4, 2024

(54) LITHIUM METAL HALIDE-BASED SOLID ELECTROLYTE FOR ALL-SOLID-STATE BATTERY HAVING NEW CRYSTAL STRUCTURE

(71) Applicants: Hyundai Motor Company, Seoul (KR); Kia Corporation, Seoul (KR); Industry-University Cooperation Foundation Hanyang University ERICA Campus, Ansan (KR)

(72) Inventors: Yong Jun Jang, Seongnam, Gyeonggi-do (KR); Seong Hyeon Choi, Hwaseong, Gyeonggi-do (KR); Sun Ho Choi, Incheon (KR); Yong Gu Kim, Suwon, Gyeonggi-do (KR); Sung Man Cho, Gwacheon, Gyeonggi-do (KR); Sang Uck Lee, Bucheon, Gyeonggi-do (KR); Byeong Sun Jun, Suwon, Gyeonggi-do (KR); Ji Hoon Kim, Ansan, Gyeonggi-do (KR)

(73) Assignees: Hyundai Motor Company, Seoul (KR); Kia Corporation, Seoul (KR); Industry-University Cooperation Foundation Hanyang University ERICA Campus, Ansan, Gyeonggi-do (KR)

(21) Appl. No.: 18/237,321

(22) Filed: Aug. 23, 2023

(30) Foreign Application Priority Data
Dec. 29, 2022 (KR) 10-2022-0188412

(51) Int. Cl. H01M 10/0562; C01F 17/36; H01M 10/0525

(52) U.S. Cl. CPC H01M 10/0562; C01F 17/36; H01M 10/0525; C01P 2002/76; C01P 2006/40; H01M 2220/20; H01M 2300/008

(57) ABSTRACT

Disclosed is a lithium metal halide-based solid electrolyte having a novel crystal structure and excellent lithium ion conductivity.

### CROSS-REFERENCE TO RELATED APPLICATION

This application claims, under 35 U.S.C. § 119(a), the benefit of priority from Korean Patent Application No. 10-2022-0188412, filed on Dec. 29, 2022, the entire contents of which are incorporated herein by reference.

### TECHNICAL FIELD

The present disclosure relates to a lithium metal halide-based solid electrolyte having a novel crystal structure and excellent lithium ion conductivity.

### BACKGROUND

Recently, secondary batteries have been widely used not only in large devices such as automobiles, power storage systems, etc. but also in small devices such as mobile phones, camcorders, laptop computers, etc.

As the fields of application of secondary batteries have been increasing, there also is an increasing demand for improved safety and high performance of batteries.

A lithium secondary battery, which is one of the secondary batteries, has an advantage of high energy density and high capacity per unit area compared to a nickel-manganese battery or a nickel-cadmium battery.

However, most electrolytes used in conventional lithium secondary batteries have been liquid electrolytes such as organic solvents. Hence, safety issues such as leakage of electrolyte and the risk of fire due thereto have been constantly raised.

Accordingly, all-solid-state batteries using solid electrolytes instead of liquid electrolytes are receiving great attention these days in order to increase the safety of lithium secondary batteries.

Since the solid electrolyte is incombustible or flame retardant, safety thereof is greater than that of the liquid electrolyte. Also, since it may be manufactured in a bipolar structure, the volumetric energy density may be increased about 5 fold compared to conventional lithium ion batteries.

Solid electrolytes include oxide-based electrolyte and sulfide-based solid electrolyte. Since the sulfide-based solid electrolyte has greater lithium ion conductivity than the oxide-based solid electrolyte and is stable in a wide voltage range, the sulfide-based solid electrolyte is mainly used.

However, sulfide-based solid electrolytes have very low electrochemical stability and cause cell deterioration by side reactions with electrodes. Moreover, sulfide-based solid electrolytes have poor stability in the atmosphere, and thus, lithium ion conductivity is greatly decreased during actual use.

With the goal of overcoming the above disadvantages of conventional sulfide-based solid electrolytes, interest in lithium metal halide-based solid electrolytes has been increasing.

### SUMMARY

In preferred aspects, the present disclosure provides a lithium metal halide-based solid electrolyte for an all-solid-state battery having excellent lithium ion conductivity.

A term “all-solid-state battery” as used herein refers to a rechargeable secondary battery that includes an electrolyte in a solid state for transferring ions between the electrodes of the battery.

A term “lithium metal halide-based solid electrolyte” as used herein refers to an electrolyte component that is formed in a solid phase, and contains at least one lithium atom or ion, at least one metal atom or ion (e.g., metal other than lithium) at least one halogen atom or ion in the polymer matrix.

In one aspect, provided is a solid electrolyte represented by Chemical Formula 1 below and having a crystal structure belonging to a space group P3̅m1 [162]:

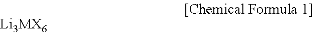

wherein in Chemical Formula 1, M may include one or more selected from the group consisting of Group 3 elements, Group 13 elements, and lanthanide elements, and X may include one or more selected from the group consisting of chlorine (Cl), bromine (Br), and iodine (I).

The solid electrolyte may be represented by Li₃YCl₆.

The solid electrolyte may include a pathway of lithium ions in a plane formed by an a-axis and a c-axis of the crystal structure.

The solid electrolyte may have a crystal structure in which element M and element X have the same orientation.

The solid electrolyte may have a crystal structure in which a layer containing element M and a layer containing element Li are separated from each other.

In the solid electrolyte, element Li may occupy about 75% or more of a 2c site.

In the solid electrolyte, element Li may occupy about 75% or more of a 2d site.

In another aspect, provided is an all-solid-state battery including the solid electrolyte as described herein.

In further aspect, provided is a vehicle that includes the all-solid-state battery as described herein.

Other aspects of the invention are disclosed infra.

### BRIEF DESCRIPTION OF THE DRAWINGS

The above and other features of the present disclosure will now be described in detail with reference to certain exemplary embodiments thereof illustrated in the accompanying drawings, which are given hereinbelow by way of illustration only, and thus are not limitative of the present disclosure, and wherein:

FIG. 1 shows an exemplary all-solid-state battery according to an exemplary embodiment of the present disclosure;

FIG. 2 shows an exemplary process of predicting a crystal structure using a particle swarm optimization algorithm;

FIG. 3 shows an exemplary crystal structure of a solid electrolyte according to an exemplary embodiment of the present disclosure;

FIG. 4A shows results of analysis of the probability density of lithium ions in the solid electrolyte according to an exemplary embodiment of the present disclosure;

FIG. 4B shows results of analysis in the axial direction different from FIG. 4A; and

FIG. 5 shows results of analysis of lithium ion diffusivity of the solid electrolyte according to an exemplary embodiment of the present disclosure using a mean square displacement (MSD) technique.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Moreover, when such a range pertains to integer values, all integers including the minimum value to the maximum value are included, unless otherwise indicated. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

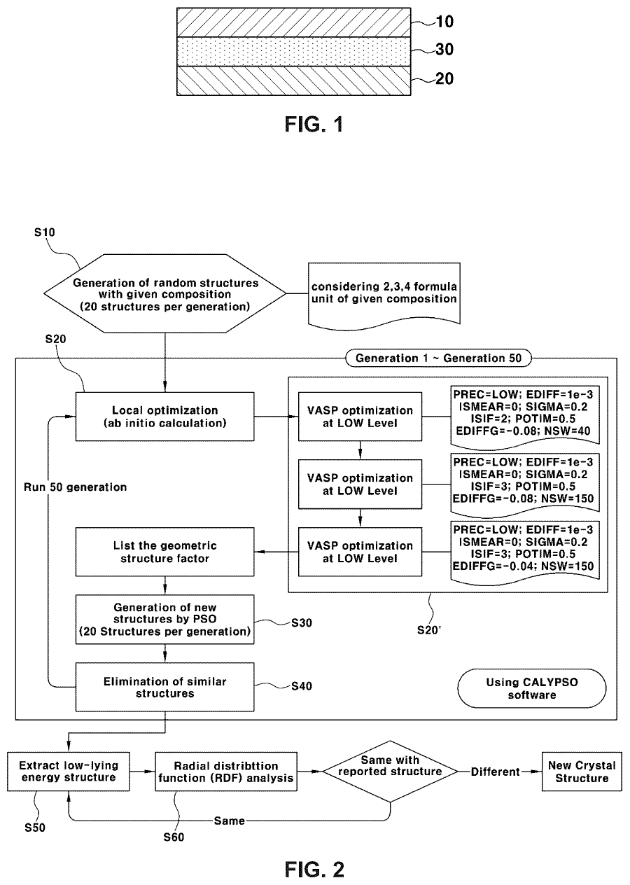

FIG. 1 shows an exemplary all-solid-state battery according to an exemplary embodiment of the present disclosure. With reference thereto, the all-solid-state battery may include a cathode 10, an anode 20, and a solid electrolyte layer 30 interposed between the cathode 10 and the anode 20. At least one selected from among the cathode 10, the anode 20, and the solid electrolyte layer 30 may include a lithium metal halide-based solid electrolyte according to the present disclosure.

The lithium metal halide-based solid electrolyte may include lithium, a metal element (M), and a halogen element. As the metal element (M), a metal or semi-metal having a divalent, trivalent, or tetravalent oxidation number is mainly used.

In particular, Li₃MX₆, which is a lithium metal halide-based solid electrolyte containing a metal element (M) having a trivalent oxidation number, has three crystal structures belonging to the space groups C2/m [12], P3̅1m [164], and Pnma [62]. A number in [ ] of each space group may represent a space group number. Lithium metal halide-based solid electrolytes, even if they have the same composition, have been reported to have higher lithium ion conductivity due to a different crystal structure depending on the synthesis method. Briefly, there is a sufficient possibility of synthesizing a lithium metal halide-based solid electrolyte having a new crystal structure.

The present disclosure proposes a lithium metal halide-based solid electrolyte having excellent lithium ion conductivity by virtue of a crystal structure different from that of conventional cases.

The solid electrolyte according to the present disclosure may be represented by Chemical Formula 1 below and may have a crystal structure belonging to P3̅1m [162].

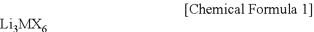

In Chemical Formula 1, M may include an element having a trivalent oxidation number. Specifically, M may include one or more selected from the group consisting of Group 3 elements, Group 13 elements, and lanthanide elements.

Preferably, M may include one or more selected from among Group 3 elements, Group 13 elements, and lanthanide elements.

The Group 3 element may preferably include scandium (Sc) or yttrium (Y).

The Group 13 element may preferably include aluminum (Al), gallium (Ga), or indium (In).

In Chemical Formula 1, X may include one or more selected from the group consisting of chlorine (Cl), bromine (Br), and iodine (I). Preferably, X may include chlorine (Cl), bromine (Br), or iodine (I).

The solid electrolyte may be represented by Li₃YCl₆.

The solid electrolyte may have a crystal structure belonging to the space group P3̅1m [162] among crystal structures of the trigonal crystal system. That the solid electrolyte has a crystal structure belonging to the space group P3̅1m means that about 80% or greater, about 90% or greater, about 95% or greater, or about 99% or greater of the solid electrolyte has a crystal structure belonging to the space group P3̅1m [162]. Here, percentages may be based on mass or volume.

The solid electrolyte according to the present disclosure is characterized by superior lithium ion conductivity compared to conventional solid electrolytes having crystal structures belonging to the space groups C2/m [12], P3̅1m [164], Pnma [62], and the like. This result was obtained using the particle swarm optimization (PSO) algorithm. The particle swarm optimization algorithm is a distributed motion algorithm that performs a multi-dimensional search, and is a methodology that searches for an energetically stable crystal structure or a crystal structure that exhibits stability equivalent thereto by moving particles within a search space, that is, a unit cell of a crystal, based on the position and speed of the particles. Therefore, it is very efficient in predicting not only thermodynamically stable crystal structures known experimentally, but also metastable crystal structures that may be synthesized experimentally but have not yet been observed. The present disclosure pertains to a lithium metal halide-based solid electrolyte having a novel crystal structure that exhibits excellent lithium ion conductivity using the particle swarm optimization algorithm.

FIG. 2 shows an exemplary process of predicting a crystal structure using a particle swarm optimization algorithm. The crystal structure prediction process using the particle swarm optimization algorithm according to the present disclosure is as follows. For example, (S10) A composition to be developed is defined (e.g., Li₃MX₆). Twenty structures having formula weights corresponding to 2 to 4 times the formula weight of the defined composition are randomly generated per generation (e.g., Li₆M₂X₁₂, Li₉M₃X₁₈, Li₁₂M₄X₂₄). (S20) The structure is optimized using ab initio calculation. (S20′) Here, the structure optimization level proceeds in the order of low, normal, and high. (S30) Twenty new crystal structures are generated by a particle swarm optimization (PSO) algorithm. (S40) Structures similar to the previous structure are eliminated. S20 to S40 are repeated 50 times. (S50) The most energetically stable structure is extracted. (S60) The extracted structure is compared with the previously reported crystal structure by radial distribution function (RDF) analysis to determine whether it is a new crystal structure. When the extracted crystal structure is different from the existing crystal structure, it is selected as the crystal structure of the present disclosure. The optimizer may use VASP (Vienna Ab initio Simulation Package), and the particle swarm optimization (PSO) algorithm may use CALYPSO software.

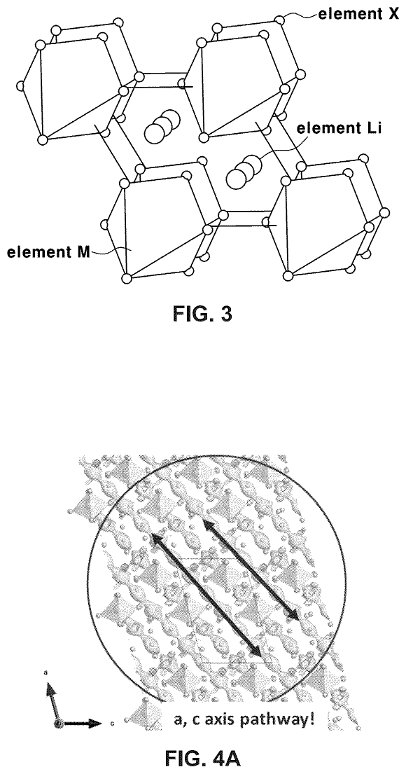

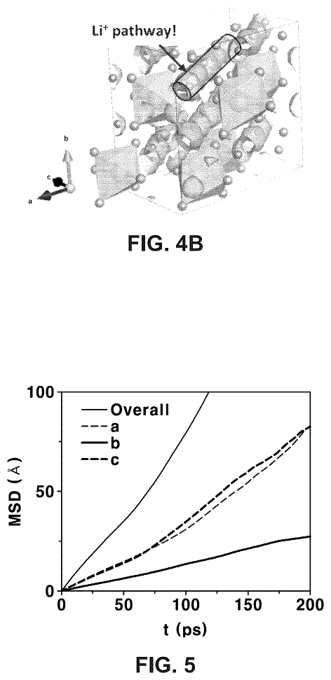

FIG. 3 shows the crystal structure of the solid electrolyte according to an exemplary embodiment of the present disclosure. FIG. 4A shows results of analysis of the probability density of lithium ions in the solid electrolyte according to the present disclosure. Specifically, AIMD (Ab Initio Molecular Dynamics) simulation is performed on the solid electrolyte, and the movement trajectory of lithium ions is tracked during simulation at a specific temperature to calculate the probability density of lithium ions present in the crystal structure, which is then represented using a pymatgen-diffusion add-on analysis tool. Here, an isosurface may be about 0.005. FIG. 4B shows results of analysis in the axial direction different from FIG. 4A. In FIGS. 4A and 4B, portions where lithium ions are likely to be distributed are represented in yellow. The solid electrolyte is configured such that the pathway of lithium ions extends long continuously in a plane formed by the a-axis and the c-axis of the crystal structure. In the solid electrolyte, lithium ions may easily move through two-dimensional diffusion in the a-axis and c-axis, resulting in excellent lithium ion conductivity.

FIG. 5 shows results of analysis of lithium ion diffusivity in the solid electrolyte according to an exemplary embodiment of the present disclosure using a mean square displacement (MSD) technique. The movement of lithium ions may be active in the a-axis and c-axis directions.

Table 1 below shows the results of calculating the lithium ion conductivity of the solid electrolyte according to an exemplary embodiment of the present disclosure having a crystal structure belonging to the space group P3̅1m and the conventional solid electrolyte. An energetically optimized initial structure is obtained from each crystal structure. AIMD (Ab Initio Molecular Dynamics) simulations are performed at temperatures of about 600K, about 800K, about 1,000K, and about 1,200K for the optimized initial structure. Particularly, simulation may be performed by setting the minimum time to 100 ps, and may be carried out 4 times at each temperature until the relative standard deviation (RSD) satisfying Equation 1 below is less than 0.25.

$$R S D = \frac{{S}_{D}}{{D}_{true}} = \frac{3.43}{\sqrt{{N}_{eff}}} + 0.44 \qquad [ Equation 1 ]$$

RSD: Relative standard deviation
S_{D}: Standard deviation of short simulation
Dₜᵣᵤₑ: Calculated diffusivity from longest available MD simulation
N_{eff}: Effective number of ion hops of all mobile ions

Then, the trajectory of the AIMD simulation may be analyzed to extract the mean square displacement (MSD). This is to calculate the preliminary lithium ion conductivity using the MSD extraction value and the Einstein diffusion equation. For example, the trajectory of the AIMD simulation may be analyzed by extracting the positions of ions per unit time of the simulation, MSD may be calculated using Equation 2 below, and diffusivity D may be calculated using Equation 3 below.

$$MSD = 〈 {[ Δ r ( t ) ]}^{2} 〉 = \frac{1}{N} {\sum }_{i} 〈 {[ {r}_{i} ( t + {t}_{0} ) ]}^{2} - {[ {r}_{i} ( {t}_{0} ) ]}^{2} 〉 \qquad [ Equation 2 ]$$

$${D}_{τ} = \frac{1}{2 dt} M S D \qquad [ Equation 3 ]$$

Then, the diffusivity at a temperature of about 300K may be inferred from the preliminary lithium ion conductivity by Arrhenius fitting. Particularly, since the ion diffusivity in a solid without phase transition satisfies the Arrhenius correlation of Equation 4 below, the diffusivity at a temperature of about 300K may be inferred by Arrhenius fitting of the diffusivity obtained by simulation at a high temperature of about 600K to 1,200K. The lithium ion conductivity at a temperature of about 300K may be finally calculated by substituting the diffusivity at a temperature of about 300K obtained by fitting into the Einstein diffusion equation of Equation 5 below.

$$D = {D}_{0} exp ( - \frac{{E}_{a}}{kT} ) \qquad [ Equation 4 ]$$

$${σ}_{300 K} = \frac{ρ {z}^{2} {F}^{2}}{RT} {D}_{300 K} \qquad [ Equation 5 ]$$

In Equation 5, ρ is the density of diffusion ions in the unit cell, z is the charge of the diffusion ions, F is Faraday's constant, and R is the gas constant.

The Haven ratio is calculated using Equation 6 below, and is an index indicating how many lithium ions move simultaneously when lithium ions move.

$${H}_{R} = {D}^{*} / {D}_{σ} \qquad [ Equation 6 ]$$

HR: Haven ratio
D*: trace diffusion constant
D_{σ}: diffusion constant

TABLE 1

| | | Comparative | Comparative | Comparative |
|---|---|---|---|---|
| Items | Example | Example 1 | Example 2 | Example 3 |
| Chemical | Li₃YCl₆ | | | |
| Formula | | | | |
| Crystal | P3̅1m | P3̅1m | Pnma[62] | C2/m[12] |
| Structure | [162] | [164] | | |
| Energy/ | −4.313 | −4.317 | −4.317 | −4.320 |
| atom¹⁾[eV] | | | | |
| Lithium ion | 38.6 | 0.6 | 10.5 | 3.9 |
| conductivity | | | | |
| [mS/cm] | | | | |
| Haven ratio | 2.50 | 0.40 | 0.16 | 1.28 |

¹⁾Energy/atom is the value obtained by dividing the energy of the crystal structure by the total number of constituent elements.

As show in the above Table 1, the lithium ion conductivity and Haven ratio of the solid electrolyte according to an exemplary embodiment of the present disclosure may have vastly superior compared to the conventional solid electrolytes.

Table 2 below shows structural information of the solid electrolyte according to an exemplary embodiment of the present disclosure having a crystal structure belonging to the space group P3̅1m [162].

TABLE 2

| Element | x | y | z | Occ. | Site | Sym. |
|---|---|---|---|---|---|---|
| Li1 | 0.3333 | 0.6667 | 0.0000 | 0.75 | 2c | 3.2 |
| Li2 | 0.3333 | 0.6667 | 0.5000 | 0.75 | 2d | 3.2 |
| Y1 | 0.0000 | 0.0000 | 0.0000 | 1.00 | 1a | −3.m |
| Cl1 | 0.33935 | 0.33935 | −0.23576 | 1.00 | 6k | ..m |

As shown in Table 2, the solid electrolyte according to an exemplary embodiment of the present disclosure has a crystal structure in which MX₆ has the same orientation, unlike solid electrolytes having crystal structures belonging to the conventional space groups P3̅m1 [162], Pnma [62], and the like. Briefly, in the solid electrolyte according to an exemplary embodiment of the present disclosure represented by Chemical Formula 1, element M and element X have the same orientation.

Moreover, in the solid electrolyte according to various exemplary embodiments of the present disclosure, element Li occupies only about 75% of the 2c and 2d sites. This means that a space that may be occupied by element Li exists, and lithium ions may diffuse easily in a manner that fills an adjacent space, thereby contributing to improvement in lithium ion conductivity.

Meanwhile, as shown in FIG. 3, in the solid electrolyte according to an exemplary embodiment of the present disclosure, the transition metal represented by M and element Li are clearly separated from each other. This means that one layer is formed with the transition metal and another layer is formed with element Li. As such, in the solid electrolyte according to various exemplary embodiments of the present disclosure, any one layer containing the transition metal and another layer containing element Li may be separated from each other to form a two-dimensional lithium ion pathway. This can be seen from the fact that Li1 and Li2 in Table 2 have the same x and y coordinates, but the x and y coordinates of yttrium (Y), a transition metal, are far apart therefrom.

According to various exemplary embodiments of to the present disclosure, a lithium metal halide-based solid electrolyte for an all-solid-state battery having excellent lithium ion conductivity can be obtained.

The effects of the present disclosure are not limited to the above-mentioned effects. It should be understood that the effects of the present disclosure include all effects that can be inferred from the description of the present disclosure.

Although the present disclosure has been described in detail above, the scope of the present disclosure is not limited thereto, and various modifications and improvements made by those skilled in the art using the basic concept of the present disclosure defined in the following claims are also included in the scope of the present disclosure.

What is claimed is:

1. A solid electrolyte represented by Chemical Formula 1 below and having a crystal structure belonging to a space group P3̅m1 [162]: 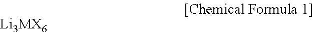
wherein:
M comprises one or more selected from the group consisting of Group 3 elements, Group 13 elements, and lanthanide elements,
X comprises one or more selected from the group consisting of chlorine, bromine, and iodine.

2. The solid electrolyte of claim 1, which wherein the solid electrolyte is represented by Li₃YCl₆.

3. The solid electrolyte of claim 1, wherein the solid electrolyte comprises a pathway of lithium ions in a plane formed by an a-axis and a c-axis of the crystal structure.

4. The solid electrolyte of claim 1, wherein the solid electrolyte has a crystal structure in which an orientation of element M is identical to an orientation of element X.

5. The solid electrolyte of claim 1, wherein the solid electrolyte has a crystal structure in which a layer comprising element M and a layer comprising element Li are separated from each other.

6. The solid electrolyte of claim 1, wherein element Li occupies about 75% or greater of a 2c site.

7. The solid electrolyte of claim 1, wherein element Li occupies about 75% or greater of a 2d site.

8. An all-solid-state battery comprising the solid electrolyte of claim 1.

9. A vehicle comprising the all-solid-state battery of claim 8.
